(19) United States
(12) Patent Application Publication
(10) Pub. No.: US 2022/0209809 A1
(43) Pub. Date: Jun. 30, 2022

(54) SOUND DIRECTING PROTECTIVE CASES

(71) Applicant: CATALYST LIFESTYLE LIMITED, Hong Kong (HK)

(72) Inventors: Joshua Wright, Hong Kong (HK); June Lai, Hong Kong (HK)

(73) Assignee: CATALYST LIFESTYLE LIMITED, Hong Kong (HK)

(21) Appl. No.: 17/563,414

(22) Filed: Dec. 28, 2021

Related U.S. Application Data
(60) Provisional application No. 63/131,565, filed on Dec. 29, 2020.

(51) Int. Cl. H04B 1/3888

(52) U.S. Cl. CPC H04B 1/3888

(57) ABSTRACT

Protective cases that direct sound are disclosed. A protective case for an electronic device includes a body defining a cavity for receiving the electronic device. The body includes one or more walls arranged about a perimeter of the cavity. The one or more walls define a plurality of sound direction channels extending through the body. At least one first sound direction channel of the plurality of sound direction channels extends through the body in a first direction and at least one second sound direction channel of the plurality of sound direction channels extending through the body in a second direction different from the first direction.

### CROSS-REFERENCE TO RELATED APPLICATION

The present application claims the priority benefit of U.S. Provisional Application No. 63/131,565, entitled “Sound Directing Protective Cases” and filed Dec. 29, 2020, the entire contents of which is hereby incorporated herein.

### BACKGROUND

### Field

The present specification generally relates to protective cases that cover electronic devices and, more specifically, to cases having sound directing features.

### Technical Background

As background, certain electronic devices (e.g., smartphones, tablets, or the like) may have various sound ports that are co-located and can cause interference during some calls. For example, an electronic device may have a noise canceling microphone positioned next to a speaker, and certain audio output from the speaker (e.g., during speakerphone calls) may cause the noise canceling microphone to temporarily shut off. Similar issues may occur when an electronic device is placed within a case (e.g., the electronic device functions normally when in a case, but the above-noted issues result when placed in a case and used). This results in poor call quality, as individuals on the other end of the call may witness “choppy” audio, audio that sporadically becomes muted, or audio that is at a low volume and difficult to hear. Existing solutions provide workarounds that are inconvenient, require deactivation of certain device features, and/or require software updates that may be time consuming and costly to develop and install.

### SUMMARY

In an aspect, a protective case for an electronic device includes a body defining a cavity for receiving the electronic device. The body includes one or more walls arranged about a perimeter of the cavity. The one or more walls define a plurality of sound direction channels extending through the body. At least one first sound direction channel of the plurality of sound direction channels extends through the body in a first direction and at least one second sound direction channel of the plurality of sound direction channels extending through the body in a second direction different from the first direction.

In another aspect, protective case for an electronic device includes a body defining a cavity for receiving the electronic device. The body includes one or more walls arranged about a perimeter of the cavity, the one or more walls having an interior surface and an exterior surface opposite the exterior surface. The one or more walls define a plurality of sound direction channels extending through the body from the interior surface to the exterior surface. At least one first sound direction channel of the plurality of sound direction channels extends nonlinearly within the body such that an opening of the at least one first sound direction channel in the exterior surface faces a first direction. At least one second sound direction channel of the plurality of sound direction channels extends through the body such that an opening of the at least one second sound direction channel in the exterior surface faces a second direction different from the first direction.

In yet another aspect, a protective case for an electronic device includes a body defining a cavity for receiving the electronic device. The body includes one or more walls arranged about a perimeter of the cavity. The one or more walls having an interior surface and an exterior surface opposite the exterior surface. The one or more walls define a first sound direction channel extending through the body. The first sound direction channel includes a first opening in the interior surface aligned with a speaker of the electronic device when the electronic device is received within the cavity and a second opening in the exterior surface. The first opening and the second opening are coupled via one or more channel walls that extend through the body. The one or more walls also define a second sound direction channel extending through the body. The second sound direction channel includes a first opening in the interior surface aligned with a microphone of the electronic device when the electronic device is received within the cavity and a second opening in the exterior surface. The first opening and the second opening coupled via one or more channel walls that extend through the body. The second opening of the first sound direction channel and the second opening of the second sound direction channel are not coplanar.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts a front perspective view of an illustrative protective case having a plurality of sound direction channels disposed within the protective case according to one or more embodiments shown and described herein;

FIG. 1B depicts a detailed front perspective view of the plurality of sound direction channels of FIG. 1A according to one or more embodiments shown and described herein;

FIG. 2 depicts a front view of the protective case of FIG. 1A, showing two of the plurality of sound direction channels according to one or more embodiments shown and described herein;

FIG. 3 depicts a bottom view of the protective case of FIG. 1A, showing one of the plurality of sound direction channels according to one or more embodiments shown and described herein;

FIG. 4 depicts a top-down view depicting an internal wall of the protective case of FIG. 1A, showing the plurality of sound direction channels according to one or more embodiments shown and described herein;

FIG. 5A depicts a side view of the protective case of FIG. 1A, showing one of the sound direction channels in phantom according to one or more embodiments shown and described herein;

FIG. 5B depicts a detailed side view of the sound direction channel of FIG. 5A according to one or more embodiments shown and described herein;

FIG. 6A depicts a side view of the protective case of FIG. 1A, showing another one of the sound direction channels in phantom according to one or more embodiments shown and described herein; and

FIG. 6B depicts a detailed side view of the sound direction channel of FIG. 6A according to one or more embodiments shown and described herein.

### DETAILED DESCRIPTION

The present disclosure generally relates to a protective case for an electronic device, the protective case having a plurality of sound direction channels formed in the protective case. At least one of the plurality of sound direction channels is formed in the protective case in such a manner that it directs sound between the exterior of the protective case and the interior of the protective case in a direction that differs from a direction of the other one(s) of the plurality of sound direction channels. Such a sound direction feature reduces, minimizes, or eliminates interference caused by co-location of speakers and microphones on an electronic device when the electronic device is inserted within the protective case, as described in greater detail herein.

An electronic device may include any electronic device such as a pager, PDA, cellphone, smart phone, tablet, laptop, or the like. Electronic devices according to the present disclosure may include a plurality of sound ports providing access to speakers and/or microphones positioned adjacent to one another. For example, an electronic device particularly referred to herein may have two speaker ports positioned adjacent to one another on a bottom surface of the electronic device, and a microphone port located next to one of the two speaker ports, the microphone port also being on the bottom surface of the electronic device. As a result of such placement, with the microphone(s) and speaker(s) being near each other, sound emitted from the speakers of the electronic device is emitted downward out of the bottom surface, and sound received by the microphone of the electronic device is received in the speaker from the bottom surface. In such an arrangement, the co-location of the speakers and microphone may cause interference with one another, which manufacturers may attempt to correct with noise canceling or other software features. However, such corrections are not always successful. As will be described herein, such electronic devices may be positioned within the protective case such that the protective case directs the sound from the speakers and/or the microphone to improve isolation and minimize or avoid interference therebetween. In addition, the protective case may provide a protective and/or waterproof housing around the electronic device.

It should be understood that while the embodiment particularly described herein relates to an electronic device having two speakers and a microphone that are each downward facing on the bottom surface of the electronic device, the present disclosure is not limited to such. That is, the protective cases described herein may be configured for any type of electronic device having any number of speakers and/or microphones co-located near each other and located at any surface of the electronic device.

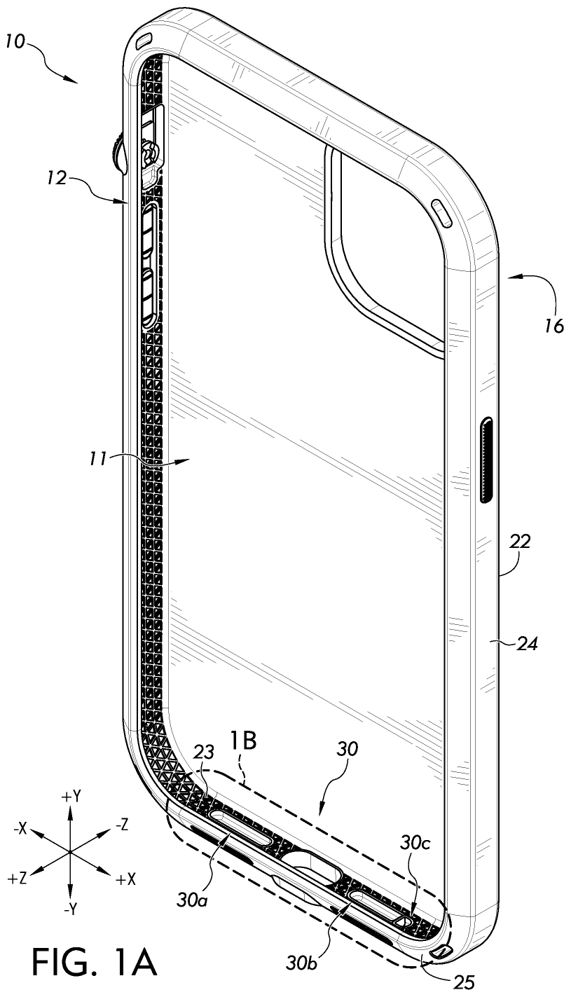

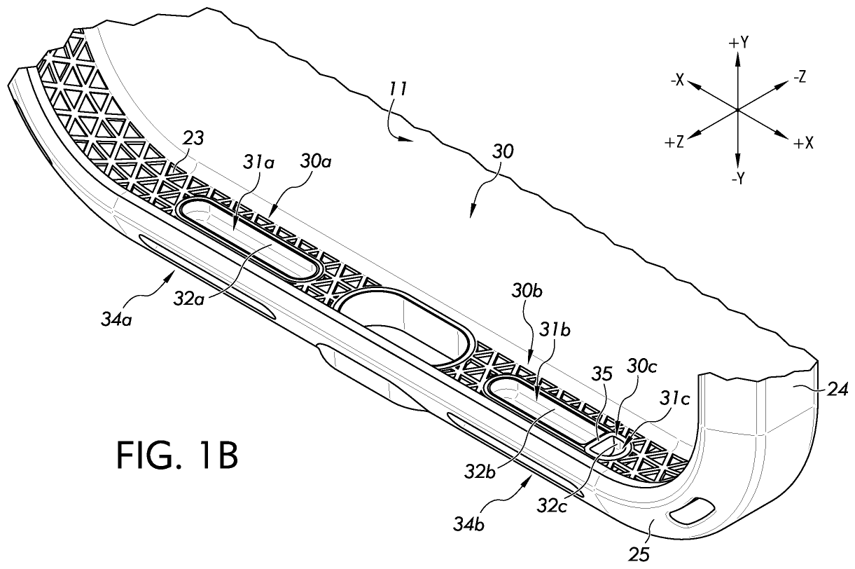

Referring to FIGS. 1A-1B, an embodiment of a protective case 10 is generally depicted. The protective case 10 includes a body 12. The body 12 includes one or more sidewalls 22 that, when the body holds an electronic device (not shown), the one or more sidewalls 22 cover at least a portion of the electronic device. In some embodiments, the one or more sidewalls 22 may be arranged in a shape that can encircle or surround a portion of the electronic device when installed (e.g., covers side walls of the electronic device, but does not cover at least a portion of a front and/or at least a portion of a back of the electronic device). In such embodiments, the protective case 10 may be referred to as a bumper case. In other embodiments, the body 12 may further include a rear wall 16. In such embodiments, the body 12 may be configured such that the sidewalls 22 extend transversely from the rear wall 16 around the edges of the rear wall 16 to define a cavity 11 within which an electronic device may be received. While the embodiment depicted in FIGS. 1A-1B is a body 12 having a single piece assembly, the present disclosure is not limited to such. That is, the body 12 may be separable into one or more components to allow for insertion of the electronic device into the cavity 11 defined by the body 12. For example, the body 12 may include a front portion and a rear portion. It is noted that each of the front portion and the rear portion may be single integral articles or may be assemblies of sub-body components. In embodiments where the front portion and the rear portion may be separably coupled to one another. That is, the front portion may be assembled to and disassembled from the rear portion repeatedly (e.g., to allow for insertion and removal of the electronic device). When the front portion is assembled to the rear portion around an electronic device, a fluid tight seal (e.g., a watertight seal and/or an airtight seal) may be formed between the front portion and the rear portion to prevent ingress or egress of liquid, dirt, or other debris, into the cavity 11 of the protective case 10, thereby protecting the electronic device within the cavity 11 from contact with liquid, dirt, or debris. That is, the protective case 10, when assembled, may provide a waterproof housing for the electronic device positioned therein.

The rear wall 16 of the body 12 may have one or more features that are arranged to correspond to one or more features of a backside of an electronic device when the electronic device is received within the cavity 11 of the protective case 10. For example, the rear wall 16 of the body 12 may include one or more camera windows that are aligned with one or more components of a camera device (e.g., a lens and/or flash) to allow for the capture of images by the electronic device when the electronic device is positioned within the protective case 10, one or more fingerprint scanner windows that are aligned with one or more components of a fingerprint scanner to allow for the capture of a fingerprint by the electronic device when the electronic device is positioned within the protective case 10, and/or the like. In addition, the rear wall 16 of the body 12 may be shaped and sized to generally correspond to the shape and size of a particular electronic device such that the electronic device, when received in the protective case 10, fits within the cavity 11 defined by the body 12. As noted hereinabove, while not depicted in FIGS. 1A-1B, in some embodiments, the rear wall 16 may be omitted such that the body 12 only includes the one or more sidewalls 22.

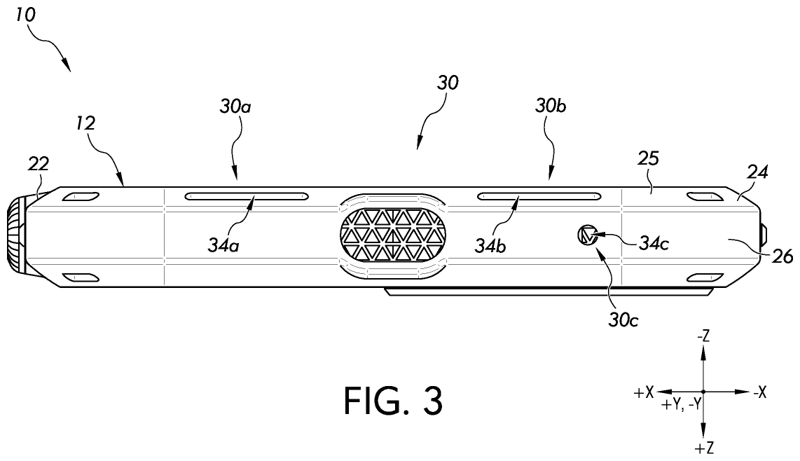

In some embodiments, the rear wall 16 may define the one or more sidewalls 22 of the body 12. The one or more sidewalls 22 may be arranged to correspond to a perimeter of the electronic device when the electronic device is positioned within the body 12. The one or more sidewalls 22 may define an interior surface 23 and an exterior surface 24 opposite the interior surface 23. In some embodiments, the electronic device is positioned on the interior surface 23 of the sidewall 22 when the electronic device is received within the cavity 11 of the protective case 10 (e.g., the interior surface 23 faces and/or contacts the electronic device). In some embodiments, the one or more sidewalls 22 may curve over the electronic device when the electronic device is inserted within the cavity 11 such that a portion of the one or more sidewalls 22 covers a portion of a face of the electronic device (e.g., a bezel of the electronic device or a portion of a bezel, a rim, or the like). In such embodiments, the sidewalls 22 may have at least a front facing portion 25 that generally faces in a direction opposite the rear wall 16 of the body 12 (e.g., in the +Z direction of the coordinate axes of the figures). The front facing portion 25 is distinguished from a downward facing portion 26 (FIG. 3) that faces the −Y direction of the coordinate axes of the figures.

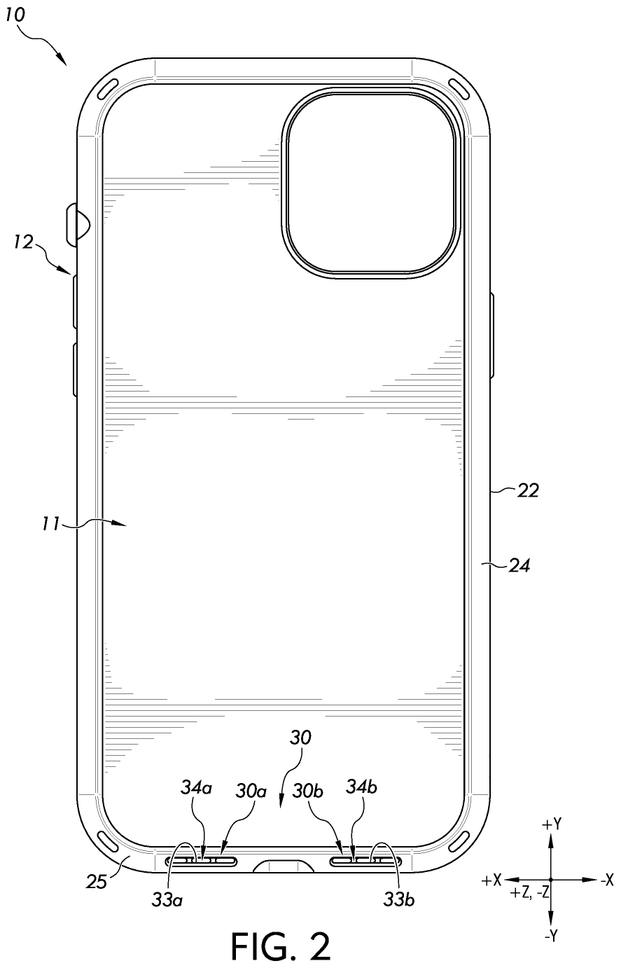

As depicted in FIGS. 1A-1B, 2-4, 5A-5B, and 6A-6B, the body 12 of the protective case 10 also defines a plurality of sound direction channels 30 that extend through the body 12 of the protective case 10 from the interior surface 23 to the exterior surface 24 of the one or more sidewalls 22. The plurality of sound direction channels 30 generally include at least one sound direction channel, shaped, sized, and aligned with a microphone of an electronic device when the electronic device is inserted in the cavity 11 and at least one sound direction channel shaped, sized, and aligned with a speaker of the electronic device when the electronic device is inserted in the cavity 11.

In the embodiment depicted in FIGS. 1A-1B, 2-4, 5A-5B, and 6A-6B, the plurality of sound direction channels 30 includes a first sound direction channel 30a, a second sound direction channel 30b, and a third sound direction channel 30c. The first sound direction channel 30a and the second sound direction channel 30b are generally, shaped, sized, and aligned with two speakers of an electronic device when the electronic device is inserted within the cavity 11 defined by the body 12 such that the first sound direction channel 30a and the second sound direction channel 30b direct the sound emitted by the speakers. The third sound direction channel 30c is generally shaped, sized, and aligned with a microphone of an electronic device when the electronic device is inserted within the cavity 11 defined by the body 12 such that the third sound direction channel 30c directs sound received by the microphone. In addition, the second sound direction channel 30b is separated from the third sound direction channel 30c via an isolation wall 35 disposed between the second sound direction channel 30b and the third sound direction channel 30c. The isolation wall 35 generally be a channel wall (as described in greater detail herein) that extends between the second sound direction channel 30b and the third sound direction channel 30c to maintain a separation of the second sound direction channel 30b from the third sound direction channel 30c. In some embodiments, the material of the body 12 at the isolation wall 35 may be formed of a sound dampening material to avoid having sound pass through the isolation wall 35.

It should be understood that such an amount and configuration of the sound direction channels 30 is merely illustrative, and other amounts and/or configurations are contemplated and included within the scope of the present disclosure. For example, the protective case 10 may define two, four, five, six, seven, eight, nine, ten, or more sound direction channels 30. In some embodiments, a sound direction channel 30 may extend to direct sound from two components. For example, a sound direction channel 30 may be shaped, sized, and positioned such that the sound direction channel 30 extends across two speakers of an electronic device when the electronic device is received within the cavity 11 defined by the body 12. Accordingly, the sound direction channel 30 (e.g., a single channel) directs sound from both speakers of the electronic device outside the body 12 as described herein. It should be appreciated that such an embodiment would by usable for electronic device components of the same type (e.g., two speakers), and would not be usable for electronic device components of differing types (e.g., a speaker and a microphone) because the sound would not be isolated as described herein.

As depicted in FIGS. 1A-1B and 2-4, each of the sound direction channels 30 is defined by first and second openings and one or more channel walls. More specifically, a first opening 31a in the interior surface 23 of the body 12 and a second opening 34a in the exterior surface 24 of the body 12 and one or more channel walls (e.g., a first channel wall 32a and/or a second channel wall 33a) extend from the interior surface 23 at the first opening 31a and the exterior surface 24 at the second opening 34a to define the first sound direction channel 30a. Similarly, a third opening 31b in the interior surface 23 of the body 12 and a fourth opening 34b in the exterior surface 24 of the body and one or more channel walls (e.g., a third channel wall 32b and/or a second channel wall 33b) extend from the interior surface 23 at the third opening 31b and the exterior surface 24 at the fourth opening 34b to define the second sound direction channel 30b. In addition, a fifth opening 31c in the interior surface 23 of the body 12 and a sixth opening 34c (FIG. 3) in the exterior surface 24 of the body and one or more channel walls (e.g., a fifth channel wall 32c) extend from the interior surface 23 at the fifth opening 31c and the exterior surface 24 at the sixth opening 34c to define the third sound direction channel 30c. In some embodiments, each of the first opening 31a, the third opening 31b, and the fifth opening 31c may correspond in shape, size, configuration, and location to a sound port on an electronic device when the electronic device is received within the cavity 11 as described herein. For example, the first opening 31a may correspond in shape, size, configuration, and location to a first speaker of the electronic device, the third opening 31b may correspond in shape, size, configuration, and location to a second speaker of the electronic device, and the fifth opening 31c may correspond in shape, size, configuration to a microphone of the electronic device. While the first sound direction channel 30a and the second sound direction channel 30b are each depicted as having two channel walls, the present disclosure is not limited to such. That is, each of the first sound direction channel 30a and the second sound direction channel may have fewer than or greater than two channel walls in other embodiments. In addition, while the third sound direction channel 30c is depicted as having a single channel wall, the present disclosure is not limited to such. That is the third sound direction channel 30c may have greater than one single channel wall.

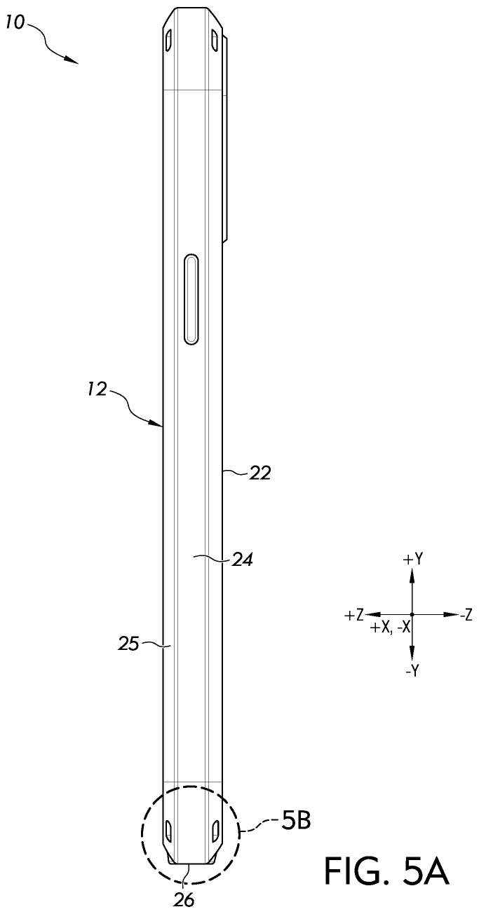

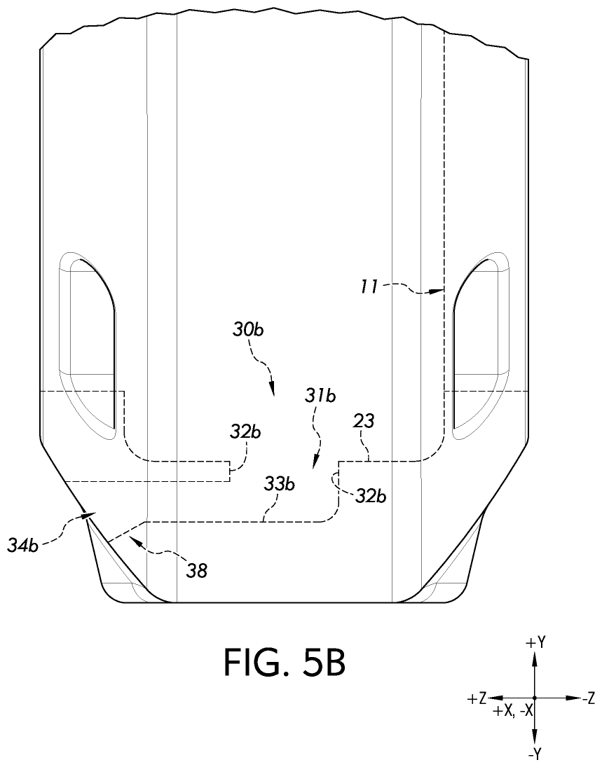

As noted herein, certain electronic devices may locate the microphone in proximity next to one or more speakers, which may cause interference during particular operation of the electronic device (such as when using the speakerphone function of the electronic device). As such, the protective case 10 of the present application utilizes the sound direction channels 30 to isolate sound emitted from the one or more speakers from the sound detected by the one or more microphones and/or redirect the sound, despite the close proximity of the components of the electronic device. More specifically, at least one of the plurality of sound direction channels 30 is arranged to direct sound in a first direction and at least another one of the plurality of sound direction channels 30 is arranged to direct sound in a second direction that is different from the first direction. In addition, the sound direction channels 30 isolate speakers from microphones on an electronic device when the electronic device is inserted in the cavity 11. That is, the sound direction channels 30 may be formed within the body 12 of the protective case 10 such that at least one of the sound direction channels 30 directs sound in a direction that is different from the direction of another one of the sound direction channels 30. As a result, this arrangement of sound direction channels 30 alter the direction of the sound detected by the electronic device when received within the cavity 11 and/or alter the direction of the sound emitted by the electronic device when received within the cavity 11. For example, as depicted in phantom in FIGS. 5A-5B and further shown in FIGS. 1A-1B and 2-4, the second sound direction channel 30b (and also the first sound direction channel 30a, which is not depicted in FIGS. 5A-5B) is nonlinear and turns at an angle within the body 12 of the protective case 10 such that fourth opening 34b is located at the front facing portion 25 of the exterior surface 24 of the sidewalls 22. That is, the third channel wall 32b extends a distance in a first direction (e.g., the −Y direction of the coordinate axes of FIGS. 5A-5B from the interior surface 23 at the third opening 31b) and the fourth channel wall 33b extends a distance in a second direction that is different from the first direction (e.g., the +Z direction of the coordinate axes of FIGS. 5A-5B toward the exterior surface 24 at the fourth opening 34b). It should be appreciated that the second sound direction channel 30b may extend in other directions without departing from the scope of the present application. Further, while the first sound direction channel 30a (FIGS. 1A-1B) is not depicted in FIGS. 5A-5B, it should be appreciated that the first sound direction channel 30a may also extend in a manner similar to the second sound direction channel 30b in some embodiments. It should also be understood that while FIGS. 5A-5B depict the second sound direction channel 30b as extending in the first direction and the second direction, the present disclosure is not limited to such. That is, the first sound direction channel 30a and/or the second sound direction channel 30b may extend in fewer than or greater than two directions or in directions different from what is depicted in FIGS. 5A-5B. Further, the various channel walls 32a, 32b, 33a, 33b that define the first sound direction channel 30a and/or the second sound direction channel 30b may have a curvature or an angled configuration instead of extending substantially straight in a first direction and then extending substantially straight in a second direction as depicted in FIGS. 5A-5B. In addition, while the first sound direction channel 30a and the second sound direction channel 30b depicted in FIGS. 5A-5B are shown as changing direction at about a 90° angle (e.g., a right angle), the present disclosure is not limited to such. That is, the sound direction channels 30 may change direction at any angle without departing from the scope of the present disclosure. Further, while the various channel walls 32a, 32b, 33a, 33b depicted in FIGS. 5A-5B are positioned such that the cross sectional shape and/or size of each of the first sound direction channel 30a and/or the second sound direction channel 30b remains consistent when traversing between openings 31a, 31b, 34a, 34b, the present disclosure is not limited to such. For example, the various channel walls 32a, 32b, 33a, 33b may be angled, flared, or the like so that the cross sectional shape and/or size varies when traversing between openings 31a, 31b, 34a, 34b. For example, a flared region 38 of the second sound direction channel 30b is depicted in FIG. 5B whereby the fourth channel wall 33b may be flared outward from a center of the second sound direction channel 30b such that the fourth opening 34b is larger than the third opening 31b. Such a flared region 38 may allow for the protective case 10 to amplify sound emitted from the electronic device when the electronic device is received within the cavity 11. While FIG. 5B specifically depicts the flared region 38 in the second sound direction channel 30b, it should be understood that the first sound direction channel 30a (FIGS. 1A-1B) may also include a similar flared region without departing from the scope of the present disclosure.

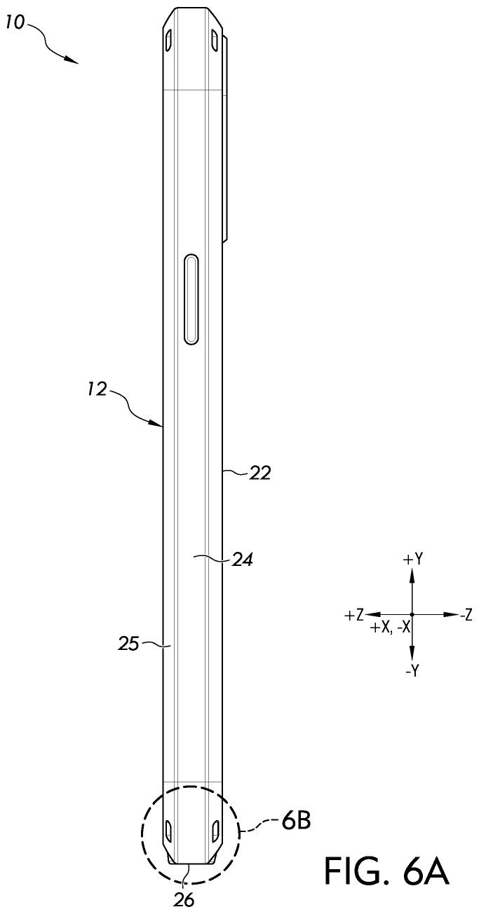

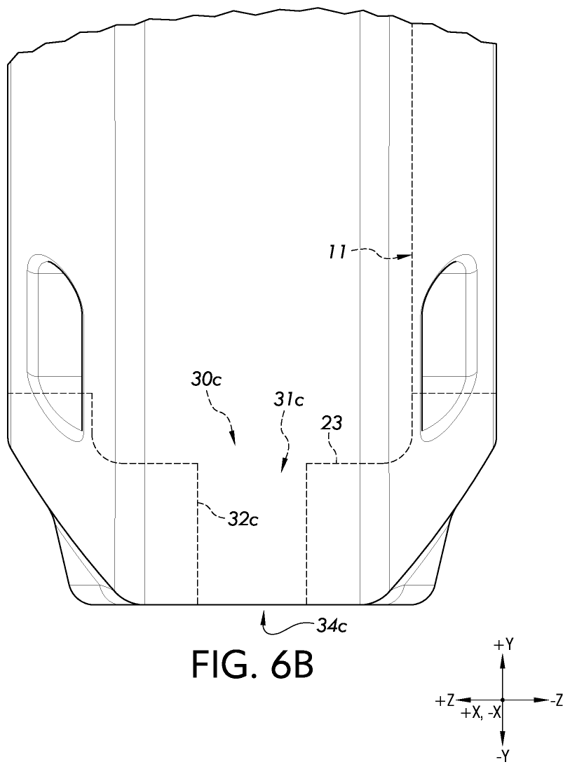

As depicted in phantom in FIGS. 6A-6B and further shown in FIGS. 1A-1B, 3, and 4, the third sound direction channel 30c extends in a single direction. That is, the fifth channel wall 32c extends a distance in one direction from the interface with the interior surface 23 at the fifth opening 31c to the interface with the exterior surface 24 at the sixth opening 34c (e.g., downward along the −Y direction of the coordinate axes of FIGS. 6A-6B) such that the sixth opening 34c is located at the downward facing portion 26 (e.g., a downward system direction towards the −Y direction) of the exterior surface 24 of the sidewalls 22. It should be appreciated that the fifth channel wall 32c that defines the third sound direction channel 30c may have a curvature or an angled configuration instead of extending substantially straight as depicted in FIGS. 6A-6B. Further, while the fifth channel wall 32c depicted in FIGS. 6A-6B is positioned such that the cross sectional shape and/or size of the third sound direction channel 30c remains consistent when traversing between openings 31c, 34c, the present disclosure is not limited to such. For example, the channel wall 32c may be angled, flared, or the like so that the cross sectional shape and/or size varies when traversing between openings 31c, 34c. For example, the fifth channel wall 32c may be flared outward from a center of the third sound direction channels 30c such that the sixth opening 34c is larger than the fifth opening 31c. Such a flared configuration may allow for the protective case 10 to transmit more sound to the electronic device when the electronic device is received within the cavity 11 relative to a non-flared configuration.

Given the foregoing description, it should now be understood that while the sound direction channels 30 may all be located in the same plane on the interior surface 23 of the one or more sidewalls 22, at least a portion of the sound direction channels 30 change direction within the body 12 so that not all of the sound direction channels 30 are located in the same plane on the exterior surface 24 of the one or more sidewalls 22. It should be appreciated that the direction of sound redirection described herein is merely illustrative, and that the sound direction channels 30 may extend in other directions without departing from the scope of the present disclosure. In addition, the direction(s) in which each of the sound direction channels 30 extend may vary based on the design of the electronic device received in the cavity 11, the design of the protective case 10 (e.g., one or more aesthetic features or functional components of the protective case 10), optimum sound input or output, and/or the like.

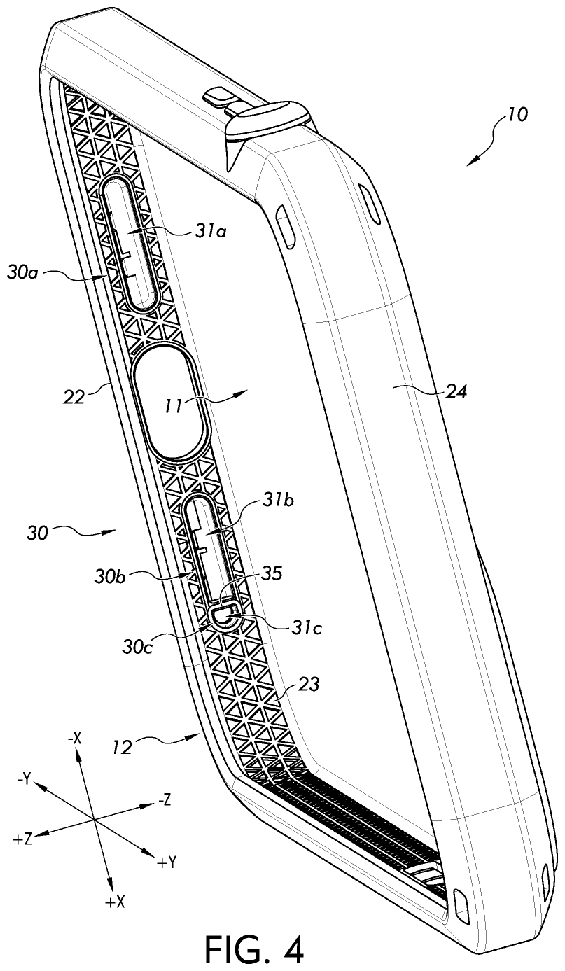

Referring to FIGS. 1A-1B and 4, the protective case 10 may further include one or more seals (not depicted), such as O-rings or the like, arranged around each one of the first opening 31a, the third opening 31b, and the fifth opening 31c on the interior surface 23 of the one or more sidewalls 22 in some embodiments. The seals may be compressed by the electronic device when the electronic device is inserted in the cavity 11 and may further function to isolate sound being received by and/or emitted from the various components of the electronic device when inserted within the cavity 11.

Referring generally to FIGS. 1A-1B, 2-4, 5A-5B, and 6A-6B, the sound direction channels 30 may generally have any size or shape, particularly sizes and/or shapes that correspond to a shape and/or size of a sound feature on an electronic device (e.g., a speaker and/or a microphone). In some embodiments, the sound direction channels 30 may have a cross sectional geometry, including, without limitation, an hourglass shaped cross section, an elliptical cross section, a circular cross section, a square cross section, a rectangular cross section, a triangular cross section, an oval (e.g., stadium shaped) cross section, and the like. Further, it should be understood that various ones of the sound direction channels 30 may be formed in the body 12 with different cross sectional geometries. In some embodiments, the sound direction channels 30 may each have a consistent cross-sectional shape when traversed from a first opening of each sound direction channel 30 on the interior surface 23 of the one or more sidewalls 22 to a second opening of each sound direction channel 30 on the exterior surface 24 of the one or more sidewalls 22 (e.g., a cylindrical shape).

In some embodiments, each one of the sound direction channels 30 may have an opening diameter, for example, of about 0.1 millimeters (mm) to about 100 mm. As used herein, the opening diameter refers to a diameter of any one of the various openings 31a, 31b, 31c, 34a, 34b, 34c of the sound direction channels 30 on the body 12. The opening of the sound direction channels 30 is generally at a location that marks a transition between the exterior surface 24 of the one or more sidewalls 22 and a sloped surface of a corresponding one of the channel walls 32a, 32b, 32c, 33a, 33b of the sound direction channel 30. Similarly, the sound direction channels 30 may each have an opening radius of about 0.05 mm to about 50 mm. As used herein, the opening radius refers to the radius from a center point of the respective openings 31a, 31b, 31c, 34a, 34b, 34c of the sound direction channels 30 in the sidewall 22. In some embodiments, the openings 31a, 31b, 31c, 34a, 34b, 34c of the sound direction channel 30 in the body 12 may be a regular shape (e.g., circular, square shaped, triangular, or the like) or may be an irregular shape (e.g., an oval/stadium shape or the like).

It should now be understood that embodiments described herein include a protective case that includes a plurality of sound direction channels formed in the protective case. The plurality of sound direction channels generally include at least one sound direction channel that extends in a first direction and at least one sound direction channel that extends in a second direction that is different from the first direction. Such an arrangement of sound direction channels as described herein reduces, minimizes, or eliminates interference caused by co-location of speakers and microphones on an electronic device when the electronic device is inserted within the protective case.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A protective case for an electronic device, the protective case comprising:
a body defining a cavity for receiving the electronic device, the body comprising one or more walls arranged about a perimeter of the cavity,
wherein the one or more walls define a plurality of sound direction channels extending through the body, at least one first sound direction channel of the plurality of sound direction channels extending through the body in a first direction and at least one second sound direction channel of the plurality of sound direction channels extending through the body in a second direction different from the first direction.

2. The protective case of claim 1, wherein the at least one first sound direction channel is aligned with a speaker of the electronic device when the electronic device is received within the cavity and the at least one second sound direction channel is aligned with a microphone of the electronic device when the electronic device is received within the cavity.

3. The protective case of claim 2, wherein the at least one first sound direction channel and the at least one second sound direction channel are disposed next to one another such that an isolation wall is disposed between the at least one first sound direction channel and the at least one second sound direction channel.

4. The protective case of claim 1, wherein the at least one first sound direction channel extends in a single direction through the one or more walls.

5. The protective case of claim 1, wherein the at least one second sound direction channel extends a distance in one direction and turns to extend in another direction through the one or more walls.

6. The protective case of claim 1, wherein:
the body further comprises a rear wall, and
the one or more walls are one or more sidewalls that extend transversely from the rear wall.

7. The protective case of claim 1, wherein:
the one or more walls are sidewalls that are arranged around the electronic device when the electronic device is disposed within the cavity,
the sidewalls comprise an interior surface and an exterior surface including a front facing portion and a downward facing portion,
the at least one first sound direction channel extends from the interior surface to the front facing portion of the exterior surface, and
the at least one second sound direction channel extends from the interior surface to the downward facing portion of the exterior surface.

8. The protective case of claim 1, wherein the one or more walls comprise an interior surface that faces the electronic device when the electronic device is inserted in the cavity.

9. The protective case of claim 8, further comprising one or more seals disposed on the interior surface around the plurality of sound direction channels, the one or more seals isolating the at least one first sound direction channel from the at least one second sound direction channel.

10. The protective case of claim 1, wherein an opening in an exterior surface of the one or more walls corresponding to the at least one first sound direction channel is flared to amplify sound passed through the at least one first sound direction channel.

11. A protective case for an electronic device, the protective case comprising:
a body defining a cavity for receiving the electronic device, the body comprising one or more walls arranged about a perimeter of the cavity, the one or more walls having an interior surface and an exterior surface opposite the exterior surface,
wherein:
the one or more walls define a plurality of sound direction channels extending through the body from the interior surface to the exterior surface,
at least one first sound direction channel of the plurality of sound direction channels extends nonlinearly within the body such that an opening of the at least one first sound direction channel in the exterior surface faces a first direction, and
at least one second sound direction channel of the plurality of sound direction channels extends through the body such that an opening of the at least one second sound direction channel in the exterior surface faces a second direction different from the first direction.

12. The protective case of claim 11, wherein the at least one first sound direction channel is aligned with a speaker of the electronic device when the electronic device is received within the cavity and the at least one second sound direction channel is aligned with a microphone of the electronic device when the electronic device is received within the cavity.

13. The protective case of claim 12, wherein the at least one first sound direction channel and the at least one second sound direction channel are disposed next to one another such that an isolation wall is disposed between the at least one first sound direction channel and the at least one second sound direction channel.

14. The protective case of claim 11, wherein:
the body further comprises a rear wall, and
the one or more walls are one or more sidewalls that extend transversely from the rear wall.

15. The protective case of claim 11, wherein:
the one or more walls are sidewalls that are arranged around the electronic device when the electronic device is disposed within the cavity,
the exterior surface comprises a front facing portion and a downward facing portion,
the opening of the at least one first sound direction channel is located on the front facing portion of the exterior surface, and
the opening of the at least one second sound direction channel is located on the downward facing portion of the exterior surface.

16. The protective case of claim 11, wherein the interior surface faces the electronic device when the electronic device is inserted in the cavity.

17. The protective case of claim 11, further comprising one or more seals disposed on the interior surface around openings in the interior surface corresponding to the plurality of sound direction channels, the one or more seals isolating sound between the at least one first sound direction channel and the at least one second sound direction channel.

18. The protective case of claim 11, wherein the opening of the at least one first sound direction channel in the exterior surface is flared to amplify sound passed through the at least one first sound direction channel.

19. A protective case for an electronic device, the protective case comprising:
a body defining a cavity for receiving the electronic device, the body comprising one or more walls arranged about a perimeter of the cavity, the one or more walls having an interior surface and an exterior surface opposite the exterior surface,
wherein:
the one or more walls define a first sound direction channel extending through the body, the first sound direction channel comprising a first opening in the interior surface aligned with a speaker of the electronic device when the electronic device is received within the cavity and a second opening in the exterior surface, the first opening and the second opening coupled via one or more channel walls that extend through the body,
the one or more walls define a second sound direction channel extending through the body, the second sound direction channel comprising a first opening in the interior surface aligned with a microphone of the electronic device when the electronic device is received within the cavity and a second opening in the exterior surface, the first opening and the second opening coupled via one or more channel walls that extend through the body, and
the second opening of the first sound direction channel and the second opening of the second sound direction channel are not coplanar.

20. The protective case of claim 19, wherein:
the second opening of the first sound direction channel is located on a front facing portion of the exterior surface, and
the second opening of the second sound direction channel is located on a downward facing portion of the exterior surface.
